(19) United States
(12) Patent Application Publication
(10) Pub. No.: US 2011/0102774 A1
(43) Pub. Date: May 5, 2011

(54) Focus Sensor, Inspection Apparatus, Lithographic Apparatus and Control System

(75) Inventors: Arnold Sinke, Eindhoven (NL); Johan Maria Van Boxmeer, Saint Oedenrode (NL)

(73) Assignee: ASML Netherlands B.V., DR Veldhoven (NL)

(21) Appl. No.: 12/921,557

(22) PCT Filed: Mar. 30, 2009
(86) PCT No.: PCT/EP2009/002301

§ 371 Date: Dec. 7, 2010

Related U.S. Application Data
(60) Provisional application No. 61/071,125, filed on Apr. 14, 2008.

(51) Int. Cl. G01J 1/00; G03B 27/52

(52) U.S. Cl. 356/123; 355/55

(57) ABSTRACT

A focus sensor comprises a confocal sensor. Within the confocal sensor there are a plurality of aperture plates positioned in front of a plurality of detectors. Rather than a conventional pinhole aperture shape there is a central aperture surrounded by a plurality of outer aperture portions.

### CROSS-REFERENCE TO RELATED APPLICATIONS

This application claims the benefit of U.S. provisional application 61/071,125, which was filed on 14 Apr. 2008, and which is incorporated herein in its entirety by reference.

### FIELD

The present invention relates to methods of inspection usable, for example, in the manufacture of devices by lithographic techniques and to methods of manufacturing devices using lithographic techniques.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to monitor the lithographic process, it is necessary to measure parameters of the patterned substrate, for example the overlay error between successive layers formed in or on it. There are various techniques for making measurements of the microscopic structures formed in lithographic processes, including the use of scanning electron microscopes and various specialized tools. One form of specialized inspection tool is a scatterometer in which a beam of radiation is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometer are known. Spectroscopic scatterometers direct a broadband radiation beam onto the substrate and measure the spectrum (intensity as a function of wavelength) of the radiation scattered into a particular narrow angular range. Angularly resolved scatterometers use a monochromatic radiation beam and measure the intensity of the scattered radiation as a function of angle.

Confocal systems are often used in lithographic apparatus and scatterometers as part of the focus sensors. A confocal sensor generates a focus error signal which can be used as part of a control loop to ensure that the substrate is in focus. Such a confocal sensor is depicted in FIG. 5 of the accompanying Figures and an example of a typical aperture plate is depicted in FIG. 6. As can be seen the aperture plate comprises a pinhole type aperture. The confocal sensor comprises detectors arranged behind the aperture plates. A confocal sensor as depicted in FIG. 5 combined with the aperture plates of FIG. 6 results in a focus signal (generated by subtracting the signal from one of the detectors from the signal from the other detector) as shown in FIG. 7. In this Figure the dashed lines indicate the signals from each of the aperture and the solid lines indicate the focus signal. As can be seen from this Figure, the focus range is limited. For example, when the focus error is large the signal is weak because the aperture plate blocks a large portion of the radiation.

Although the size of the pinhole aperture could be increased the slope of the focus signal around the focal point would become shallower, so it would be more difficult to detect the focal point. A shallower slope thus results in a less sensitive focus sensor.

### SUMMARY

It is desirable to provide a focus sensor in which the capture range is increased.

According to an aspect of the invention, there is provided a focus sensor comprising a confocal sensor comprising a plurality of plates, each plate comprising a central transmissive portion and an outer transmissive portion, the remainder of said plates being opaque.

According to a further aspect of the invention there is provided an inspection apparatus configured to measure a property of a substrate, the apparatus comprising:

an illumination system configured to condition a radiation beam;

a radiation projector configured to project radiation onto said substrate;

a high numerical aperture lens;

a detector configured to detect the radiation beam reflected from a surface of the substrate; and

a focus sensor comprising a confocal sensor comprising a plurality of plates, each plate comprising a central transmissive portion and an outer transmissive portion, the remainder of said plates being opaque.

According to a further aspect of the invention there is provided a lithographic apparatus comprising

an illumination optical system arranged to illuminate a pattern;

a projection optical system arranged to project an image of the pattern on to a substrate; and

a focus sensor comprising a confocal sensor comprising a plurality of plates, each plate comprising a central transmissive portion and an outer transmissive portion, the remainder of said plates being opaque.

According to a further aspect of the invention there is provided a control system for controlling the position of a substrate, the system comprising:

a focus sensor comprising a confocal sensor comprising a plurality of plates, each plate comprising a central transmissive portion and an outer transmissive portion, the remainder of said plates being opaque

a controller for controlling the position of said substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus;

FIG. 2 depicts a lithographic cell or cluster;

FIG. 3 depicts a first scatterometer;

FIG. 4 depicts a second scatterometer;

FIG. 5 depicts a biconfocal sensor;

FIG. 6 depicts a conventional aperture plate;

FIG. 7 is a graph showing the focus signal for the biconfocal sensor and aperture plates of FIGS. 5 and 6; and

FIG. 8 depicts a plurality of aperture plates according to the invention;

FIG. 9 depicts the intensity distribution for the aperture plate depicted in FIG. 8b;

FIG. 10 is a graph showing the focus signal for a biconfocal sensor with aperture plates shown in FIG. 8b;

FIG. 11 depicts an optimal focus signal; and

FIG. 12 depicts cross-sections of aperture plates.

### DETAILED DESCRIPTION

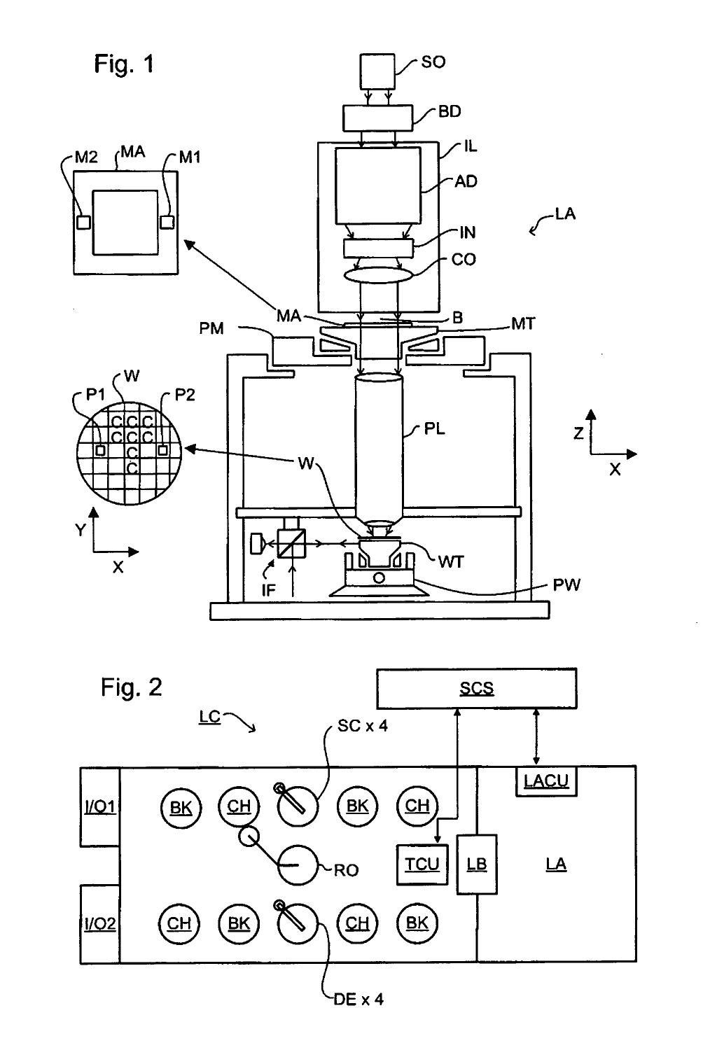

FIG. 1 schematically depicts a lithographic apparatus. The apparatus comprises:

an illumination system (illuminator) IL configured to condition a radiation beam B (e.g. UV radiation or DUV radiation).

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PL configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g. an interferometric device, linear encoder, 2-D encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 2, the lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers then to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc. If errors are detected, adjustments may be made to exposures of subsequent substrates, especially if the inspection can be done soon and fast enough that other substrates of the same batch are still to be exposed. Also, already exposed substrates may be stripped and reworked—to improve yield—or discarded—thereby avoiding performing exposures on substrates that are known to be faulty. In a case where only some target portions of a substrate are faulty, further exposures can be performed only on those target portions which are good.

An inspection apparatus is used to determine the properties of the substrates, and in particular, how the properties of different substrates or different layers of the same substrate vary from layer to layer. The inspection apparatus may be integrated into the lithographic apparatus LA or the lithocell LC or may be a stand-alone device. To enable most rapid measurements, it is desirable that the inspection apparatus measure properties in the exposed resist layer immediately after the exposure. However, the latent image in the resist has a very low contrast—there is only a very small difference in refractive index between the parts of the resist which have been exposed to radiation and those which have not—and not all inspection apparatus have sufficient sensitivity to make useful measurements of the latent image. Therefore measurements may be taken after the post-exposure bake step (PEB) which is customarily the first step carried out on exposed substrates and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibilities for rework of faulty substrates but may still provide useful information.

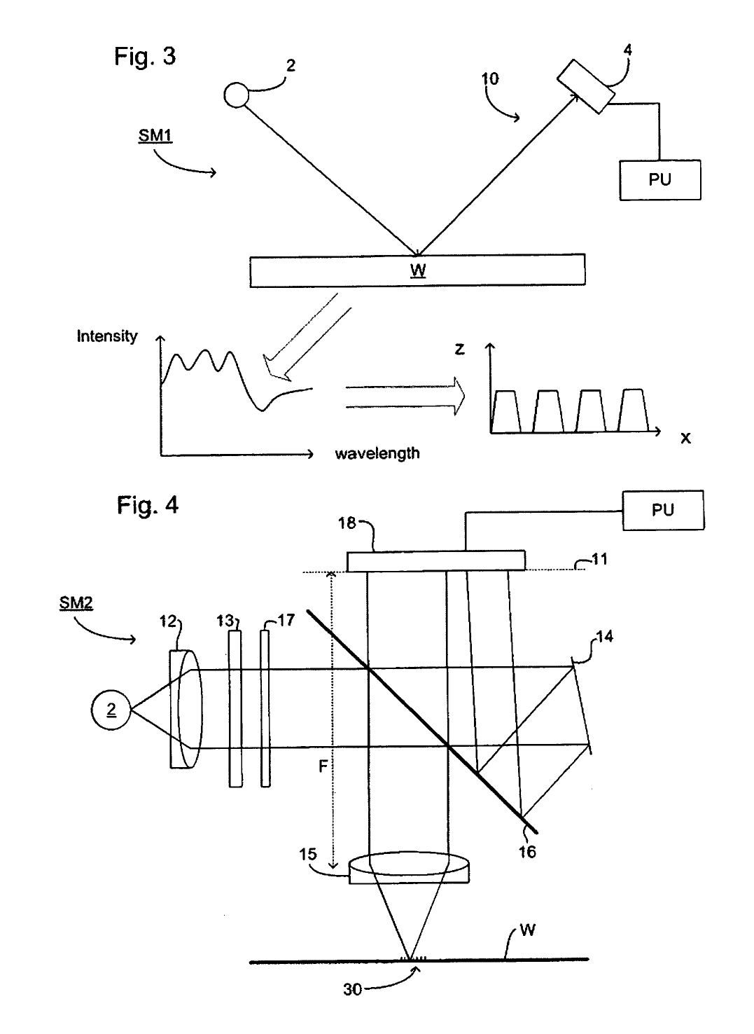

FIG. 3 depicts a scatterometer which may be used in the present invention. It comprises a broadband (white light) radiation projector 2 which projects radiation onto a substrate W. The reflected radiation is passed to a spectrometer detector 4, which measures a spectrum 10 (intensity as a function of wavelength) of the specular reflected radiation. From this data, the structure or profile giving rise to the detected spectrum may be reconstructed by processing unit PU, e.g. by Rigorous Coupled Wave Analysis and non-linear regression or by comparison with a library of simulated spectra as shown at the bottom of FIG. 3. In general, for the reconstruction the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

Another scatterometer that may be used with the present invention is shown in FIG. 4. In this device, the radiation emitted by radiation source 2 is focused using lens system 12 through interference filter 13 and polarizer 17, reflected by partially reflected surface 16 and is focused onto substrate W via a microscope objective lens 15, which has a high numerical aperture (NA), preferably at least 0.9 and more preferably at least 0.95. Immersion scatterometers may even have lenses with numerical apertures over 1. The reflected radiation then transmits through partially reflective surface 16 into a detector 18 in order to have the scatter spectrum detected. The detector may be located in the back-projected pupil plane 11, which is at the focal length of the lens system 15, however the pupil plane may instead be re-imaged with auxiliary optics (not shown) onto the detector. The pupil plane is the plane in which the radial position of radiation defines the angle of incidence and the angular position defines azimuth angle of the radiation. The detector is preferably a two-dimensional detector so that a two-dimensional angular scatter spectrum of a substrate target 30 can be measured. The detector 18 may be, for example, an array of CCD or CMOS sensors, and may use an integration time of, for example, 40 milliseconds per frame.

A reference beam is often used for example to measure the intensity of the incident radiation. To do this, when the radiation beam is incident on the beam splitter 16 part of it is transmitted through the beam splitter as a reference beam towards a reference mirror 14. The reference beam is then projected onto a different part of the same detector 18.

A set of interference filters 13 is available to select a wavelength of interest in the range of, say, 405-790 nm or even lower, such as 200-300 nm. The interference filter may be tunable rather than comprising a set of different filters. A grating could be used instead of interference filters.

The detector 18 may measure the intensity of scattered light at a single wavelength (or narrow wavelength range), the intensity separately at multiple wavelengths or integrated over a wavelength range. Furthermore, the detector may separately measure the intensity of transverse magnetic- and transverse electric-polarized light and/or the phase difference between the transverse magnetic- and transverse electric-polarized light.

Using a broadband light source (i.e. one with a wide range of light frequencies or wavelengths—and therefore of colors) is possible, which gives a large etendue, allowing the mixing of multiple wavelengths. The plurality of wavelengths in the broadband preferably each has a bandwidth of Δλ and a spacing of at least 2Δλ (i.e. twice the bandwidth). Several “sources” of radiation can be different portions of an extended radiation source which have been split using fiber bundles. In this way, angle resolved scatter spectra can be measured at multiple wavelengths in parallel. A 3-D spectrum (wavelength and two different angles) can be measured, which contains more information than a 2-D spectrum. This allows more information to be measured which increases metrology process robustness. This is described in more detail in EP1,628,164A.

The target 30 on substrate W may be a grating, which is printed such that after development, the bars are formed of solid resist lines. The bars may alternatively be etched into the substrate. This pattern is sensitive to chromatic aberrations in the lithographic projection apparatus, particularly the projection system PL, and illumination symmetry and the presence of such aberrations will manifest themselves in a variation in the printed grating. Accordingly, the scatterometry data of the printed gratings is used to reconstruct the gratings. The parameters of the grating, such as line widths and shapes, may be input to the reconstruction process, performed by processing unit PU, from knowledge of the printing step and/or other scatterometry processes.

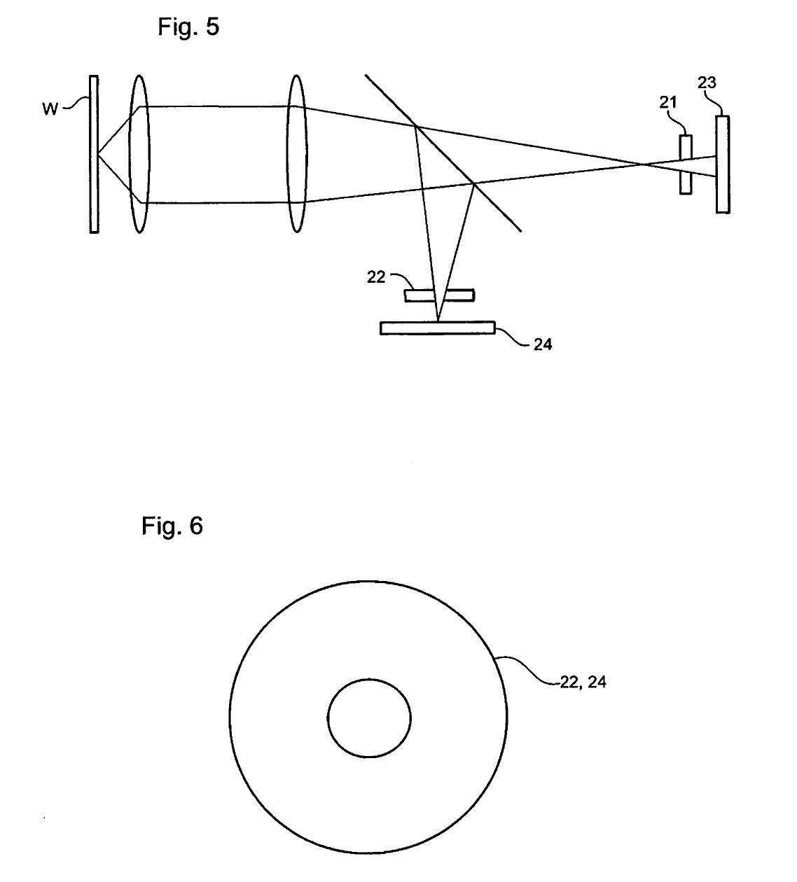

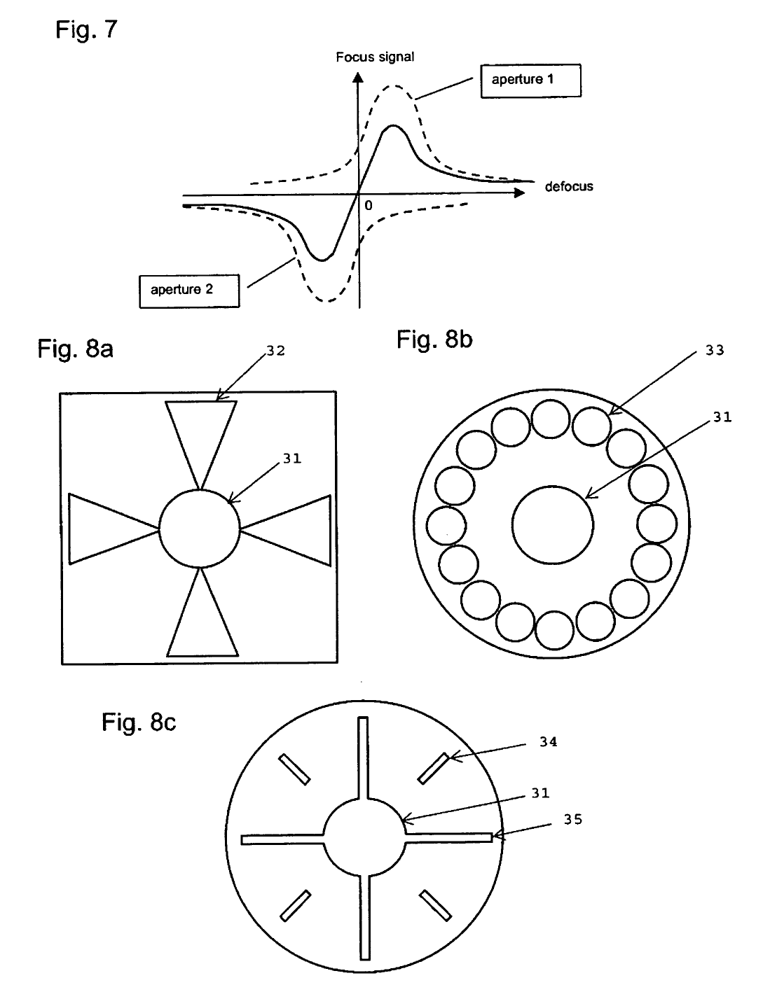

FIG. 5 depicts a biconfocal sensor with a first aperture plate 21 located in a first branch of the biconfocal sensor and behind the focal point of the sensor, and a second aperture plate 22 located in a second branch of the biconfocal sensor and in front of the focal point of the sensor. Behind the first aperture plate is located a first detector 23 and behind the second aperture plate is a second detector 24 (in this embodiment also in front of the focal point of the sensor). The two branches of the biconfocal sensor serve to generate two signals. Each signal is, as can be seen from FIG. 7 a bell shaped curve. The difference between these two signals is the focus error, which is shown as the solid line in FIG. 7. This is a roughly linear slope through the focal point and tails off as the signal becomes progressively defocused. Although this is intended to be an illustrative confocal sensor the invention is not limited to this particular biconfocal arrangement and indeed the invention can be used in conjunction with any confocal focus sensor.

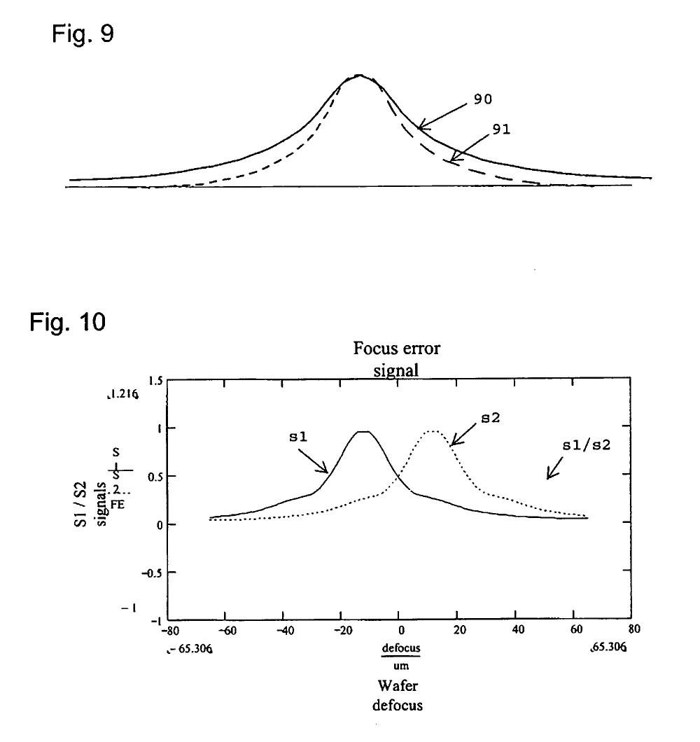

The invention relates in particular to the aperture plates 21 and 22. Aperture plates according to the invention comprise a central aperture 31 and outer aperture portions 32,33,34,35. Some example aperture plates are shown in FIG. 8. The outer aperture portions 33 serve to broaden the bell curve and a bell curve for the aperture shown in FIG. 8b is shown as curve 90 in FIG. 9. For comparison a bell curve for a typical pinhole aperture shape is shown in dotted curve 91. The outer aperture portions may comprise circular outer apertures 33, as shown in FIG. 8b, triangular shaped apertures 32 as shown in FIG. 8a, slit shaped 34 apertures as shown in FIG. 8c or indeed any other shape of aperture. The invention is not intended to be limited to the outer aperture portions depicted here and could include, for example, annulus shaped aperture portions. However, the aperture plates 21 and 22 should preferably be rotationally symmetric and preferably four or more fold rotationally symmetric. The central aperture 31 depicted here is circular, as this gives the highest degree of rotational symmetry. However, the central aperture need not be circular and could be any other shape, for example star shaped or square.

The outer aperture portions 33 may be separate and distinct from the central aperture 31 as shown in FIG. 8b. Alternatively, the outer aperture portions 32 could be contiguous with the central aperture 31, as shown in FIG. 8a. Furthermore a combination of some distinct outer aperture portions 34 and some outer aperture portions 35 which are contiguous with the central aperture 31 is also possible, as shown in FIG. 8c. To prevent erroneous readings the area of the outer aperture portions should not be larger than the area of the central aperture.

Although the invention has been described using aperture plates with transmissive portions (forming the aperture portions) and opaque portions may also be used.

FIG. 10 shows a focus error signal s1, a focus signal s2 and a signal s1/s2 resulting from a confocal sensor using aperture plates depicted in FIG. 8b. This results in a larger capture range and the focus signal for defocused substrates being larger. Furthermore the slope of the focus signal around the focal point has been maintained.

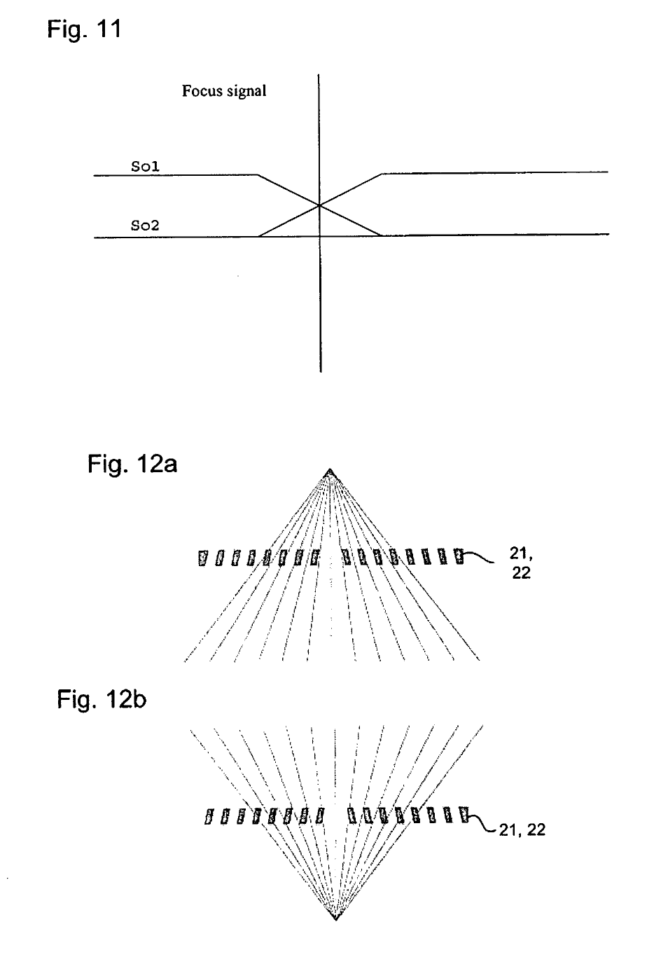

The optimal focus signal would be linear with the line represented by x=y through zero but be within a limited range. FIG. 11 shows a first and second optimal focus signal So1 and So2. To obtain a similar signal the transmission before and after the focal point must be different and this can be achieved by the slits, or apertures having a tilt (i.e. not having a uniform cross section along the path of the radiation beam). FIG. 12 depicts cross-sections of aperture plates 21,22 in which the apertures do not have a uniform cross-section. In FIG. 12a depicts a cross section of an aperture plate 21,22 wherein the focal point is behind the aperture plate whereas in FIG. 12b a cross section of an aperture plate 21,22 wherein the focal point is in front of the aperture plate.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A focus sensor comprising:
a confocal sensor comprising a plurality of plates, the plates comprising a central transmissive portion and an outer transmissive portion, the remainder of said plates being opaque.

2. The focus sensor according to claim 1 wherein said plates are aperture plates, the aperture plates comprising a central aperture and a plurality of outer aperture portions.

3. The focus sensor according to claim 1 wherein there are a plurality of the outer transmissive portions.

4. The focus sensor according to claim 1, wherein said central transmissive portion comprises a circular transmissive portion.

5. The focus sensor according to claim 1, wherein said plates have rotational symmetry about the optical axis of the focus sensor.

6. The focus sensor according to claim 1, wherein said plates have four fold rotational symmetry about the optical axis of the focus sensor.

7. The focus sensor according to claim 1, wherein said plurality of outer transmissive portions comprise a plurality of circular transmissive portions.

8. The focus sensor according to claim 1, wherein said outer transmissive portions are contiguous with said central transmissive portions.

9. The focus sensor according to claim 1, wherein said confocal sensor comprises detectors arranged behind said plates.

10. The focus sensor according to claim 1, wherein there is a first plate and a second plate, said first and second plates being identical.

11. The focus sensor according to claim 1, wherein a first plate is arranged in a first branch of said confocal sensor and a second plate is arranged in a second branch of said confocal sensor.

12. The focus sensor according to claim 1, wherein said first plate is arranged behind of a focal point of said confocal sensor and said second plate is arranged in front of the focal point of said confocal sensor.

13. The focus sensor according to claim 1, wherein said central transmissive portion has a non-uniform cross-section.

14. The focus sensor according to claim 1, wherein said outer transmissive portion has a non-uniform cross-section.

15. An inspection apparatus configured to measure a property of a substrate, the apparatus comprising:
an illumination system configured to condition a radiation beam;
a radiation projector configured to project radiation onto said substrate;
a high numerical aperture lens;
a detector configured to detect the radiation beam reflected from a surface of the substrate; and
a focus sensor comprising a confocal sensor comprising a plurality of plates, each plate comprising a central transmissive portion and an outer transmissive portion, the remainder of said plates being opaque.

16. A lithographic apparatus comprising
an illumination optical system arranged to illuminate a pattern;
a projection optical system arranged to project an image of the pattern on to a substrate; and
a focus sensor comprising a confocal sensor comprising a plurality of plates, the plates comprising a central transmissive portion and an outer transmissive portion, a remainder of said plates being opaque.

17. A control system comprising:
a focus sensor comprising a confocal sensor comprising a plurality of plates, the plates comprising a central transmissive portion and an outer transmissive portion, a remainder of said plates being opaque; and
a controller configured to control a position of a substrate.
